(19) United States
(12) Patent Application Publication
(10) Pub. No.: US 2013/0341297 A1
(43) Pub. Date: Dec. 26, 2013

(54) DRINKING CONTAINER

(71) Applicant: Sandra Saunders, Rocky River, OH (US)

(72) Inventors: Gary Stephan, Cleveland, OH (US); Craig Saunders, Cleveland, OH (US); Evan Spirk, Cleveland, OH (US); Jeffrey Kalman, Cleveland, OH (US); David Boll, Cleveland, OH (US); Anthony Zuccaro, Cleveland, OH (US); James P. Perry, Gahanna, OH (US)

(73) Assignee: ABBOTT LABORATORIES, ABBOTT PARK, IL (US)

(21) Appl. No.: 13/821,375

(22) PCT Filed: Sep. 14, 2011
(86) PCT No.: PCT/US11/51534

§ 371 Date: May 15, 2013

Related U.S. Application Data
(60) Provisional application No. 61/382,785, filed on Sep. 14, 2010.
(60) Provisional application No. 61/452,377, filed on Mar. 14, 2011.

(51) Int. Cl. A61J 9/00

(52) U.S. Cl. CPC A61J 9/00
USPC 215/11.1; 366/130

(57) ABSTRACT

A drinking container and its components are described. A cap for the baby bottle includes a reservoir for storage of a dry powder formula. A clamp ring locking indicator for a container is described. The locking indicator indicates when the clamp ring is correctly engaged to the container. A clamp ring also threads and locks to the container with an approximately 180 degree turn. A stir insert for the baby bottle is described. The stir insert is positioned in an interior of the container in order to promote the mixing of the dry powder formula with the liquid. The stir insert includes a paddle portion that oscillates or moves in a back-and-forth manner as the bottle is shaken or stirred. A system cup is described. A single container has different attachments for the period from newborn to childhood to allow a single cup to be used throughout that entire time period.

### CROSS-REFERENCE TO RELATED APPLICATIONS

This application claims the benefit of and priority to U.S. Provisional Patent Application No. 61/382,785 filed Sep. 14, 2010, and also claims the benefit of and priority to U.S. Provisional Patent Application No. 61/452,377 filed Mar. 14, 2011, the entire contents of each of the foregoing patent applications are hereby incorporated by reference in their entirety.

### FIELD OF RELEVANT ART

The present invention relates to baby bottles and drinking containers for infants and toddlers.

### BACKGROUND

Many existing baby bottle structures and containers use a clamp ring or collar structure that screws down over a top of a nipple in order to secure the nipple to the container. The tightening of the clamp ring compresses a peripheral portion of the nipple to a rim of the container. Such designs have several disadvantages. If the clamp ring securing the nipple to the container is not tightened enough, then the bottle may leak it contents from a joint between the clamp ring and the container. If the clamp ring securing the nipple to the container is tightened too tightly, then a vacuum may form in the bottle, which prevents the liquid from easily exiting the bottle. By over-tightening the clamp ring on the container, a valve or vent structure integrated into the nipple or the clamp ring may be prevented from properly functioning. The over-tightened clamp ring may force the vent or valve structure to a closed position. Such valve and vent systems allow the pressure to equilibrate between the atmosphere and the interior of the bottle to allow the liquid to flow from the bottle. The vacuum created by the over-tightened clamp ring may cause the child to suck too hard on the nipple resulting in colic or other inner ear problems. Further, the child may not be able to obtain sufficient liquid from the bottle with the over-tightened clamp ring.

Many liquid formulas for infants, newborns, and toddlers require the mixing of a dry powder formula with a liquid, such as water or milk, in order to prepare the liquid formula. When the dry powder formula is mixed with the liquid, the liquid formula should then be either immediately fed to the child or refrigerated to avoid spoilage. As such, many parents and caregivers maintain the dry powder formula separate from the water until just prior to consumption by the child. This allows the caregiver to transport and/or store the liquid and dry power formula separately for longer periods of time without worrying about spoilage. Other prior art devices use a separate powder container that is portable and carried along with a bottle that is filled with the liquid. However, this arrangement requires the busy parent or caregiver to maintain possession of the two containers. This arrangement further requires multiple containers to be washed.

The dry powder formula must generally be mixed with the liquid in order to prepare the liquid formula. When mixing the dry powder formula with water, the parent or caregiver may fill the bottle with liquid, pour the dry powder formula on top of the liquid, and then shake or move the bottle in a circular manner until the formula and the liquid is mixed. Shaking the bottle may cause the liquid in the container to mix with the formula in a more rapid manner than moving the bottle in a circular manner. However, such creates air bubbles which may cause problems with the feeding of certain babies. The consumption of gas bubbles may lead to colic or other digestive issues.

When mixing liquid with the dry powder formula, undesirable clumps of the formula may adhere or form on the bottom of the bottle. The clumps may be difficult to dissolve by shaking the bottle or rotating the bottle. Other individuals utilize a common teaspoon or tablespoon to mix the formula with the liquid. This requires an additional utensil to be maintained as well as washed.

Baby formula generally consists of a high fat emulsion of proteins. Typically, baby formula is formed by mixing the dry powder formula with a liquid, such as water. The mixing of the formula and the liquid often forms gas bubbles in the liquid formula. Bubbles in the formula may lead to digestive issues, such as colic, gas, cramps, etc. Reducing gas bubbles in liquid formula is an ongoing problem. Reducing such gas bubbles may lead to better digestion and health for the child.

Many parents and caregivers cycle or transition through a range of a variety of different bottles, cups, and other drinking vessels through the growth and maturity of a newborn, infant, toddler, and small child. A newborn typically drinks from a bottle. An infant also typically drinks from a bottle. A toddler may begin drinking out of a bottle and then transition to sippy cups that may include handles or a plain container shape. Young children often begin to learn to drink out of actual cups by using plastic, open-mouth cups that reduce spillage. This arrangement requires the purchase of multiple different drinking vessels. Further, the child outgrows conventional bottles.

### SUMMARY

In some aspects a baby bottle is provided and includes a container having a rim that defines an opening. The container also includes sidewalls extending from the rim to a bottom to define an interior for the container. A stirring member is supported by the rim and has an elongate shape to extend through the interior toward the bottom. The stifling member is flexible and moves back and forth when the baby bottle is shaken.

The stirring member can extend from a location adjacent the rim downwardly into the container. A distal end of the stifling member can be positioned in a lower half of the interior of the container. The stirring member can include a paddle having a narrow portion proximal the rim and a broad portion defining the distal end of the paddle member. The broad portion can define an opening. The stirring member can include a support collar supported by the rim and supporting the paddle. The support collar can be ring shaped and can extend around an inner surface of the rim. The support collar can include a tab extending generally inwardly into the interior. The paddle can be coupled to the tab. The support collar can be a relatively rigid material and the paddle can be a relatively flexible material. The support collar can be a thermoplastic material and the paddle can be a silicone material. The stirring member can extend from the location adjacent the rim and across a center of the container. The baby bottle can also include a nipple and a clamp ring securing the nipple to the container such that the stirring member can be secured to the rim by the clamp ring.

In other aspects a stir insert for a baby bottle is provided. The baby bottle has a bottom and the stir insert includes a ring shaped member configured to fit inside the baby bottle and a flexible elongate member extending from the ring shaped member toward the bottom when the ring shaped member is fitted inside the baby bottle.

The elongate member can have a broad portion and a narrow portion. The narrow portion can be proximal the ring shaped member and the broad portion can define a distal end of the elongate member. The broad portion can define openings through which fluid in the cylindrical container can flow during movement of the broad portion. The elongate member can move back and forth when the container is shaken, and the elongate member can be resilient and can return to an original position after moving back and forth. The ring shaped member can include an inwardly extending tab, and the flexible elongate member can be coupled to the tab. The ring shaped member and the tab can be relatively rigid, and the flexible elongate member can be relatively flexible.

In still other aspects a baby bottle is provided and includes a container for liquids, and a stir insert. The container includes an opening defined by a rim, and sidewalls extending from the rim to a bottom to define an interior. The stir insert includes an inner collar with an external diameter to fit within the opening, and a paddle portion supported by the inner collar.

The paddle portion can extend into a lower half of the interior and may not contact the bottom of the container. The paddle portion can include a narrow portion integral with a broad portion. The narrow portion can extend from the rim of the container and across a center of the container. The broad portion can be positioned proximal the bottom of the container. The broad portion can define an opening. The inner collar can be formed of a relatively rigid material and the paddle portion can be formed of a relatively flexible material. The baby bottle can also include a clamp ring securable about the opening such that the stir insert can be secured to the container by the clamp ring.

In still other aspects a stirring insert for a baby bottle is provided. The baby bottle includes an opening. The stirring insert includes an inner collar with an external diameter sized to fit inside the opening. A paddle portion is supported by the inner collar and extends away from the opening.

The paddle portion can include a narrow portion and a broad portion, and the broad portion can be farther from the opening than the narrow portion. The paddle portion can be configured to oscillate when the baby bottle is shaken. The narrow portion can bend and flex as the broad portion moves back and forth. The broad portion can define an opening. The inner collar can be a rigid material and the paddle portion can be a flexible material. The inner collar can define an inwardly extending tab, and the paddle portion can be coupled to and extend from the tab.

In still other aspects, a stifling insert for a baby bottle is provided. The baby bottle defines a mouth. The stir insert includes a support member securable within the mouth of the baby bottle, and a paddle portion supported by the support member. The paddle portion extends away from the mouth and is flexible to move back and forth when the baby bottle is shaken.

The paddle portion can include a narrow portion proximal to the opening and a broad portion spaced from the opening. The broad portion can define one or more openings. Formula and liquid in the baby bottle can pass through the one or more openings when the baby bottle is shaken. The support member can define an aperture that receives an insert portion of an upper end of the paddle portion. The insert portion can include a shaft extending from the upper end of the paddle portion. The shaft can transition into a widened portion, and the widened portion can include a tapered portion that transitions into a protruding portion. An upper end of the paddle portion can attach to the support member by a flanging connection that holds the upper end of the paddle portion to the support member. The insert portion can include a shaft extending from the upper end of the paddle portion. The shaft can transition into a widened portion, and a wall can extend away from the shaft. The insert portion can include a shaft extending from the upper end. The shaft can transition into a widened portion, and a wall can extend away from the shaft. The aperture can include a wide opening portion and a narrow opening portion, and the widened portion of the shaft can pass through the wide opening portion, and the wall can insert into the narrow opening portion. An outer diameter of the widened portion can squeeze through the wide opening portion and can be lockingly held in place as sides of the wide opening portion are received by an annular notch formed between the widened portion and the upper end of the paddle portion. The paddle portion can be removably coupled to the support member.

In still other aspects, a baby bottle is provided and includes a container having a rim defining an opening, sidewalls extending from the opening to define an interior, and a bottom. The baby bottle also includes a stir insert having ring shaped support member that fits in the opening and a mixing member coupled to the support member. The support member includes a tab that extends inwardly and toward the bottom of the container. The mixing member is coupled to the tab. The mixing member includes a flexible elongated narrow portion extending downwardly and toward a center of the container, and a broad paddle portion at an end of the narrow portion. The broad paddle portion is positioned in a lower half of the interior and defines an opening. A nipple covers the opening, and a clamp ring engages the rim to secure the nipple and the stir insert to the container. The broad paddle portion moves side to side within the interior to agitate liquid held by the container when the baby bottle is shaken.

In still other aspects, a baby bottle is provided and includes a nipple, a container having threaded portions on an outer neck surface, and a clamp ring engageable with the container. The threaded portions include a stop member. The clamp ring holds the nipple to the container and includes a threaded portion that terminates in a thread end and a projecting member on an inner surface of the clamp ring. The projecting member is circumferentially spaced from the thread end such that the thread end engages the stop member to prevent over tightening of the clamp ring on the container.

The projecting member of the clamp ring can pass over the stop member of the container and the stop member can be positioned between the projecting member and the thread end. The thread end of the clamp ring can also include an axially and radially extending contact surface. The engagement of the clamp ring to the container can provide a detent when the clamp ring is secured to the container. The container can include the threaded portions on the outer neck surface, and the threaded portions can include the stop member. The stop member can be generally perpendicular to the threaded portions. The stop member can include axially and radially extending surfaces, and the thread end of the clamp ring can press against or approach the stop member in a circumferential direction when the clamp ring is engaged to the container. The clamp ring can be made from a more flexible material than the outer neck surface of the container. When the clamp ring is engaged with the container, the projecting member can pass over the stop member of the outer neck surface and the thread end can press against the stop member to prevent the over-tightening of the clamp ring. As the clamp ring is engaged with the container, the projecting member can slide over a top of the stop member such that the projecting member is urged away from the outer neck surface and thereby deforming the clamp ring. After the projecting member clears the stop member, the clamp ring can return to its original shape and the projecting member can move back toward the outer neck surface in a detent manner. The container can include an indicator and the clamp ring can define an opening. When the thread end engages the stop member the indicator can be positioned in the opening. The indicator can include at least one of a colored, textured, and raised surface on the container. The container can have an hour-glass shape. The container can include a narrowed waist region, and the waist region can include indentations. The indentations can include triangular shapes.

In still other aspects, a container is provided and includes an opening defined by a neck portion, sidewalls extending from the neck portion to a bottom to define an interior, a threaded portion on the neck portion, and a stop member extending from an end of the threaded portion in a direction generally perpendicular to the threaded portion.

The threaded portion can include a first thread and a second thread, and the stop member can be a first stop member. The first thread can end in the first stop member and the second thread can end in a second stop member. The first stop member can be opposite of the second stop member. The first thread can extend around a first approximately 180 degrees of the opening, and the second thread can extend around a second approximately 180 degrees of the opening. The stop member can include a first portion having a first radial height and a second portion having a second radial height greater than the first radial height. The first and second portions can define a step of the stop member. The first portion can be nearer the opening than the second portion.

In still other aspects, a clamp ring for a baby bottle is provided and includes a substantially annular flange that defines an opening and that is configured to receive a nipple. A generally cylindrical sidewall extends axially away from the flange and defines at least one aperture that opens in a radial direction. The sidewall also includes an inner surface defining a threaded portion.

The threaded portion can include two threads each extending approximately 180 degrees. The sidewall can include an outer surface defining a ribbed gripping surface. The at least one aperture can be positioned below the ribbed gripping surface. The threaded portion can include two threaded portions each ending in stop surface, and the threaded portion can also include two projecting members extending radially inwardly from the inner surface and circumferentially spaced from a respective stop surface. The aperture can be a through hole in the sidewall.

In still other aspects, a baby bottle is provided and includes a nipple, a container including an indicator, and a clamp ring that engages to the container and holds the nipple to the container. The clamp ring defines at least one opening, and the indicator is viewable through the at least one opening when the clamp ring is tightened to the container.

The indicator can include at least one of a colored, textured, and raised surface on the container. The at least one opening can include a shape similar to a shape of the indicator. The indicator portion can include a shape that projects from the container, and at least one opening receives the shape when the clamp ring is fully engaged to the container. The container can include a first threaded portion and a first stop surface, and the clamp ring can include a second threaded portion engageable with the first threaded portion and a second stop surface. During tightening of the clamp ring onto the container, the second stop surface can engage the first stop surface to prevent over tightening, and when the second stop surface engages the first stop surface, the indicator can be viewable through the at least one opening.

In still other aspects, a cap for a baby bottle is provided and includes an upper portion and a bottom portion separate from the upper portion. The bottom portion has a first side that is releasably securable to the baby bottle, and a second side that is releasably securable to the upper portion to define a reservoir.

The upper portion can include a first threaded portion that can threadably engage to a second threaded portion formed on the second side of the of the bottom portion. The upper portion can include sidewalls that are integral with a top surface, and the top surface can define an opening. The cap can also include a lid hingedly connected to the upper portion and affording access to the reservoir. The lid can include a depressed portion defined by descending walls, and the descending walls can seal against opening rim walls when the lid is snapped to a closed position. The bottom portion can include a rim defining an internal diameter, and the rim can snap fit to the baby bottle. The bottom portion can include a containment surface that extends generally perpendicular to sidewalls. The containment surface can include a nipple receiving portion defining an open nipple volume.

In still other aspects, a baby bottle is provided and includes a container including a rim defining an opening, sidewalls extending from the rim to a bottom to define an interior, and a threaded portion on the sidewalls adjacent the rim. The threaded portion includes a stop member. The baby bottle also includes a nipple having a fluid opening and a perimeter portion around the fluid opening. The perimeter portion defines a valve. The baby bottle also includes a clamp ring for securing the nipple to the container. The clamp ring includes a flange that defines a nipple opening, and sidewalls that extend from the flange. The sidewalls include an inner surface that defines a threaded portion. The threaded portion ends in a thread end, a projecting member extends from the inner surface, and a space separates the thread end from the projecting member. The clamp ring rotates until the thread end contacts the stop member.

Contact between the thread end and the stop member can prevent an over-tightening of the clamp ring. Contact between the thread end and the stop member can prevent closure of the valve. The projecting member can pass over the stop member during attachment of the clamp ring to the container to provide a detent engagement indicative of proper securement of the clamp ring to the container.

In still other aspects, a nipple for a baby bottle is provided and includes a shaft. The shaft includes an opening for the passage of liquid and is integral with a raised structure. The raised structure is integral with a base.

The base and the raised structure can be spaced apart. The raised structure can be elevated from the base. The base and the raised structure can be connected by a wall. The raised structure can position a user's nose a distance from the base. A gap or space can be formed between a baby's face or nose and an outer surface of the nipple when the baby's mouth is latched to the shaft. A baby's mouth can seal against at least one of the raised structure and the shaft while the baby's nose is separated from the base.

In still other aspects, a nipple for a baby bottle is provided and includes a base including a base surface and a middle portion that is raised from the base. The middle portion includes a middle portion surface. The nipple also includes a shaft extending from the middle portion.

In still other aspects, a nipple for a baby bottle is provided and includes a base having a base surface, a raised section integral with the base, and a shaft integral with the raised section. The raised section includes a raised section surface and the base transitions into a wall at a first transition point. The wall transitions into the raised section at a second transition point. The shaft includes an opening for the passage of liquid.

### BRIEF DESCRIPTION OF THE DRAWINGS

FIG. 1 is a perspective view of a baby bottle.

FIG. 2 is a front view of the baby bottle of FIG. 1.

FIG. 3 is a rear view of the baby bottle of FIG. 1.

FIG. 4 is a side view of the baby bottle of FIG. 1.

FIG. 5 is a top view of the baby bottle of FIG. 1.

FIG. 6 is a bottom view of the baby bottle of FIG. 1.

FIG. 7 is an exploded view of the baby bottle of FIG. 1.

FIG. 8 is a perspective view of a container of the baby bottle of FIG. 1.

FIG. 9 is a side view of the container of FIG. 8.

FIG. 10 is a front view of the container of FIG. 8.

FIG. 11 is a close-up view of the locking indicator of the container of FIG. 8.

FIG. 12 is a perspective view of a stirring insert for the baby bottle of FIG. 1.

FIG. 13 is a front view of the stifling insert of FIG. 12.

FIG. 14 is a top view of the stifling insert of FIG. 12.

FIG. 15 is a perspective view of a nipple for the baby bottle of FIG. 1.

FIG. 16 is a front view of the nipple of FIG. 15.

FIG. 17 is a top view of the nipple of FIG. 15.

FIG. 18 is a top, perspective view of a clamp ring for the baby bottle of FIG. 1.

FIG. 19 is a front view of the clamp ring of FIG. 18.

FIG. 20 is a side view of the clamp ring of FIG. 18.

FIG. 21 is a top view of the clamp ring of FIG. 18.

FIG. 22 is bottom, perspective view of the clamp ring of FIG. 18.

FIG. 23 is a section view of the clamp ring of FIG. 18 locking to the container of FIG. 8.

FIG. 24 is a section view similar to FIG. 23 of the clamp ring locking to the container.

FIG. 25 is a view of the baby bottle of FIG. 1 with a cap removed.

FIG. 26 is a sectional view of the baby bottle of FIG. 25 with the cap removed.

FIG. 27 is an enlarged sectional view showing the portion of FIG. 25 encircled by the broken line.

FIG. 28 is a perspective view of a powder cap for the baby bottle of FIG. 1

FIG. 29 is an exploded view of the powder cap of FIG. 28.

FIG. 30 is a front view of the powder cap of FIG. 28.

FIG. 31 is a rear view of the powder cap of FIG. 28.

FIG. 32 is a side view of the powder cap of FIG. 28.

FIG. 33 is a top view of the powder cap of FIG. 28.

FIG. 34 is a bottom view of the powder cap of FIG. 28.

FIG. 35 is a sectional view of the powder cap of FIG. 28 coupled to the container of FIG. 8.

FIG. 36 is a perspective view of an overcap for the baby bottle of FIG. 1.

FIG. 37 is a side view of the overcap of FIG. 36.

FIG. 38 is a bottom view of the overcap of FIG. 36.

FIG. 39 is a sectional view of the overcap attached to the baby bottle.

FIG. 40 is a perspective view of a two-piece stifling insert for the baby bottle of FIG. 1.

FIG. 41 is a perspective view of a system cup attached to breast pump.

FIG. 42 is a perspective view of a system cup with a closing lid.

FIG. 43 is a perspective view of a system cup with a sippy lid with handles.

FIG. 44 is a perspective view of a system cup with a sippy lid.

FIG. 45 is a perspective view of a system cup with a rim.

FIG. 46 is a perspective view of a second container.

FIG. 47 is a front view of the second container of FIG. 46.

FIG. 48 is a side view of the second container of FIG. 46.

FIG. 49 is a perspective view of a second stifling insert configured for use with the second container of FIG. 46.

FIG. 50 is an exploded view of the second stirring insert of FIG. 49.

FIG. 51 is perspective view of another embodiment of a stifling insert.

FIG. 52 is an exploded perspective view of the stirring insert of FIG. 51.

FIG. 53 is a top view of an inner collar for the stirring insert of FIG. 51.

FIG. 54 is a bottom view of the inner collar of FIG. 53.

FIG. 55 is a front view of the inner collar of FIG. 53.

FIG. 56 is a side view of the inner collar of FIG. 53.

FIG. 57 is a section view taken along line 57-57 of FIG. 55.

FIG. 58 is a close-up view of the opening of the inner collar taken along line 58-58 of FIG. 57.

FIG. 59 is a perspective view of a paddle portion of the stirring insert of FIG. 51.

FIG. 60 is a side view of the paddle portion of FIG. 59.

FIG. 61 is a front view of the paddle portion of FIG. 59.

FIG. 62 is a rear view of the paddle portion of FIG. 59.

FIG. 63 is a close-up view of the portion of the paddle portion that is encircled by a broken line in FIG. 60.

FIG. 64 is a perspective view of another embodiment of the paddle portion of FIG. 59.

FIG. 65 is a perspective view of a nipple.

FIG. 66 is a cross-sectional view of the nipple of FIG. 65.

FIG. 67 is a top view of the nipple of FIG. 65.

FIG. 68 is a front view of the nipple of FIG. 65.

FIG. 69 is a rear view of the nipple of FIG. 65.

### DETAILED DESCRIPTION

A drinking container is described herein. As used herein, the drinking container includes cups, vessels, liquid holding structures, and containers that engage nipples and/or sippy lids suitable for use in feeding newborn, infants, and small children, as well as containers that engage rims and lids suitable for independent drinking by children and others. The drinking container further includes storage vessels and receptacles for receiving or storing breast milk, formula, juice, milk, and other liquid foods and beverage.

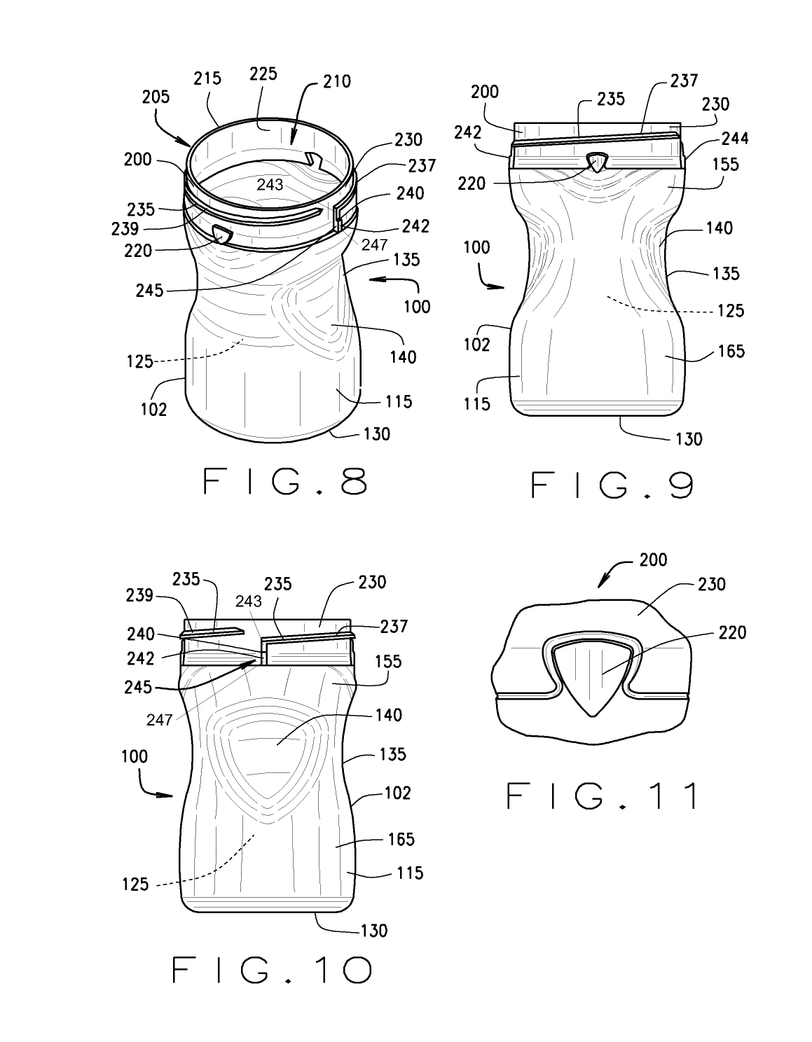

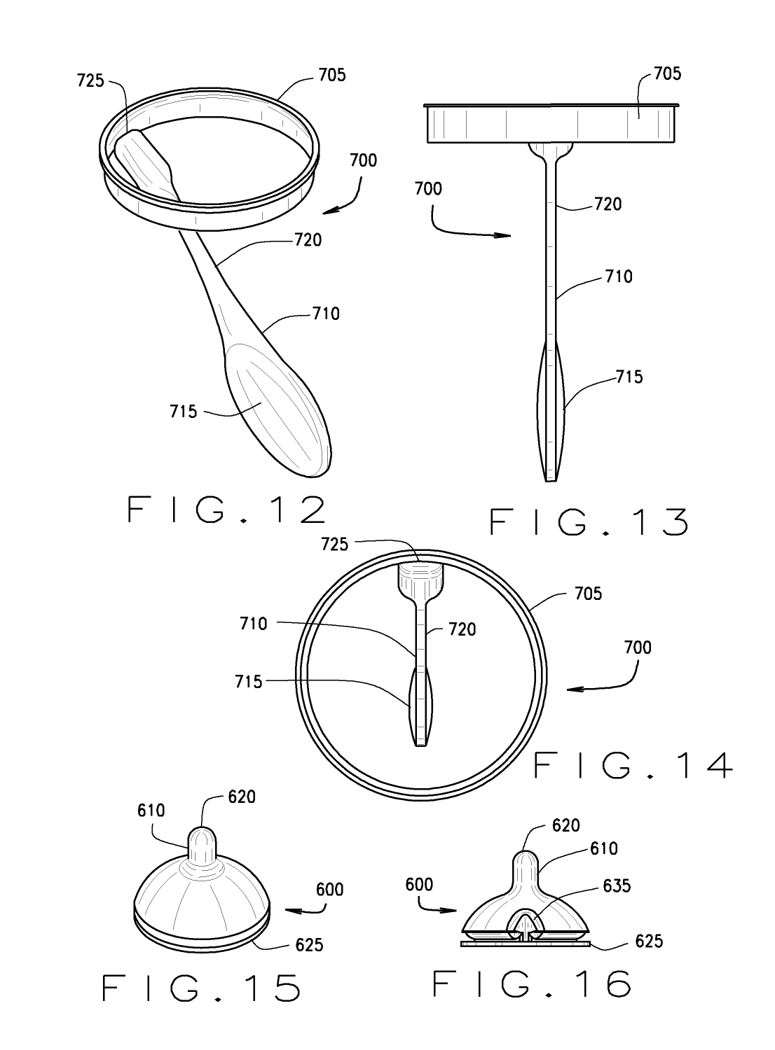

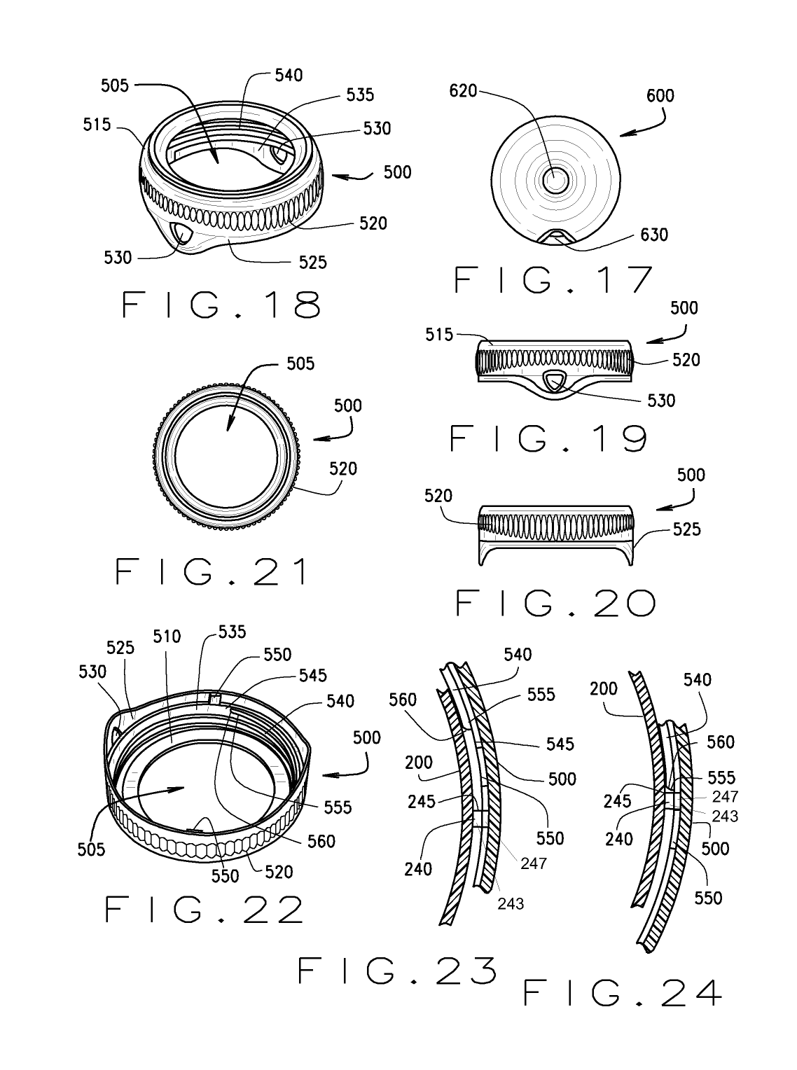

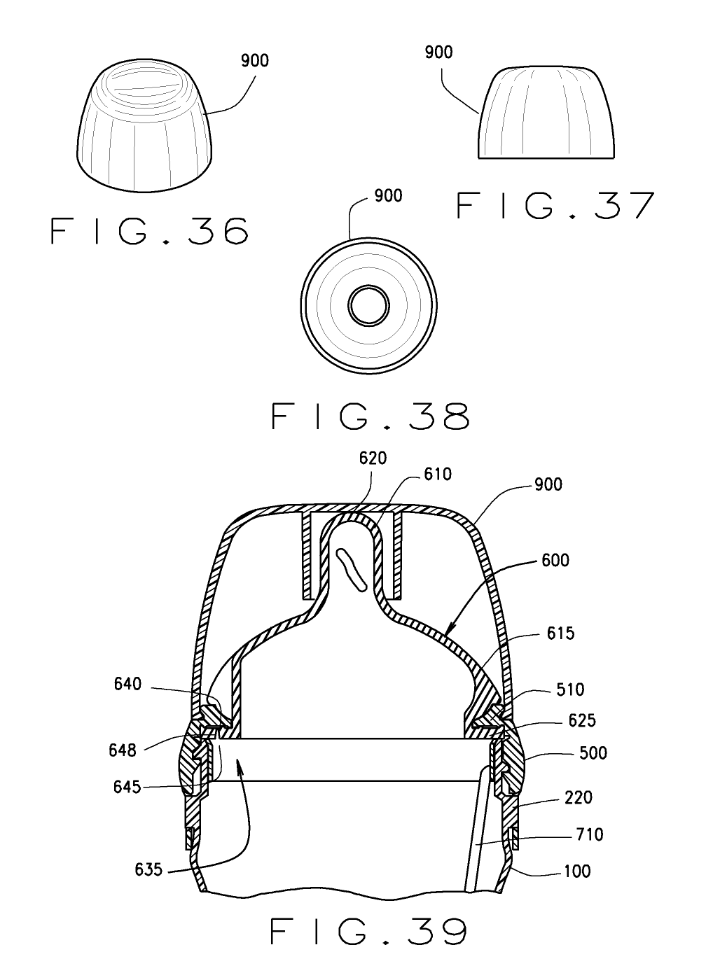

A baby bottle 50 and its components will now be described with reference to FIGS. 1-39. The bottle 50 includes a container 100 for holding a liquid, such as a powder-based formula, breast milk, pre-mixed liquid formulas, water, juice or other liquids suitable for drinking. The bottle 50 may be used with a variety of dry powder formulas, including SIMILAC® formula, commercially available from Abbott Nutrition.

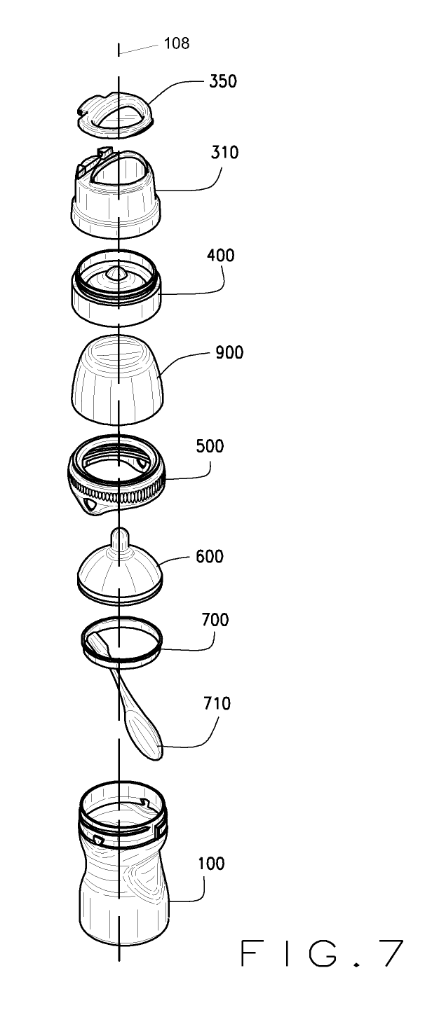

As shown in FIG. 7, the various components of the bottle 50 can be assembled along a central axis 108. A clamp ring 500 secures a nipple 600 to the container 100. A cap 300 attaches to the clamp ring 500 to enclose the nipple 600. The container 100 includes an optional stirring insert 700 to assist in mixing a dry powder formula with the liquid contained in the container 100.

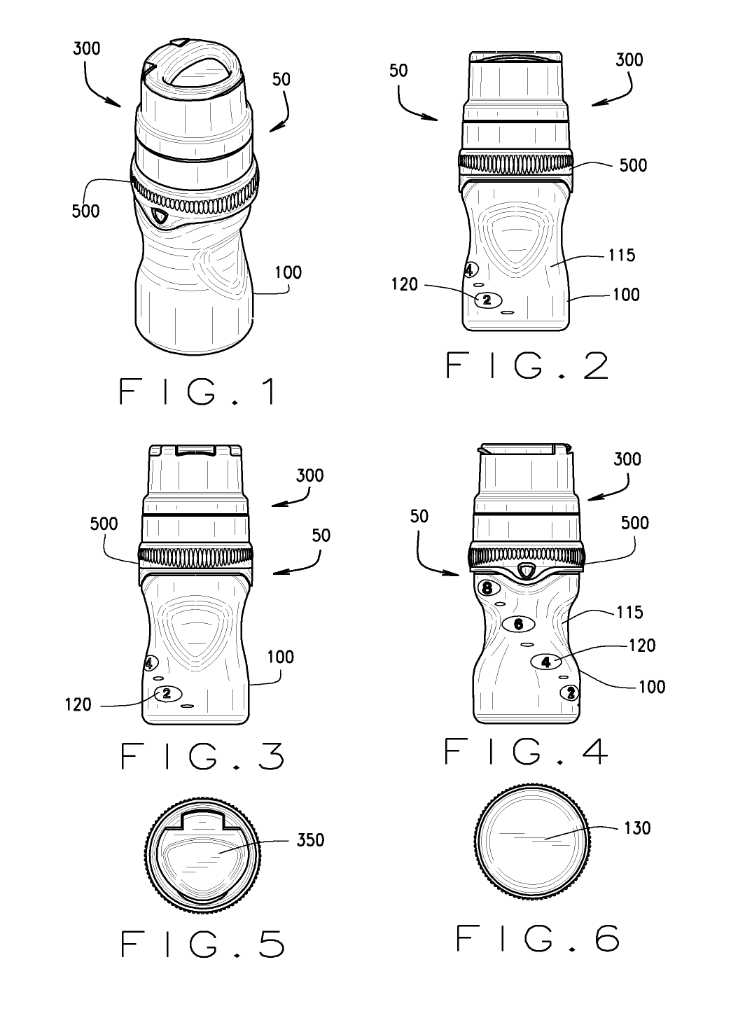

The container 100 will now be described with reference to FIGS. 8-11. The container 100 includes sidewalls 102 extending upwardly from a base 130. The sidewalls 102 include inner side surfaces 110 that, along with an inner bottom surface 105, define a volume 125 that maintains the liquid in the container 100. Outer side surfaces 115 of the container 100 may display graphics 120 (FIGS. 2-4) to indicate a level of the liquid within the interior volume 125 of the container 100. The outer side surfaces 115 may further include graphics or insignia of, for example, characters, trademarks, branding, designs, etc.

An approximate middle portion of the container 100 includes a waist region 135 that is narrower than an upper portion 155 of the container 100 and a lower portion 165 of the container 100. This provides an hour-glass shape to the container 100, which is easier for children to grip and/or hold. The waist region 135 includes one or more indentations 140 that also assist the user in gripping the container 100.

The upper portion 155 of the container 100 includes a neck portion 200. The neck portion 200 receives both the nipple 600 and the clamp ring 500. The neck portion 200 includes a rim 205 that defines a mouth or opening 210. The opening 210 provides for the ingress of liquid into the container 100 for filling the container 100 and for the egress of the liquid from the interior volume 125 to the nipple 600 during feeding or drinking. The opening 210 is extra wide to facilitate easy cleaning, as the hand of an adult may fit into the opening 210.

A bottom surface of the nipple 600 rests on a top surface 215 of the neck opening 200. The clamp ring 500, as it tightens to the container 100, seals the nipple 600 to the top surface 215. The rim 205 transitions to an inner neck surface 225 in an interior of the container 100. An outer neck surface 230 includes threaded portions 235 that receive and engage threaded portions 540 of the clamp ring 500. The threaded portions 235 extend circumferentially around the neck opening 200. Terminal ends of the threaded portions 235 define stop members 240 that extend radially outwardly from the outer neck surface 230 and in a generally axial direction. The stop members 240 include a first portion 243 having a first height in the radial direction and a second portion 247 having a second height in the radial direction that is greater than the first height. Also, the first portion 243 is nearer the opening 210 than the second portion 247. The stop members 240 therefore each include a step defined by the varying heights of the first portion 241 and the second portion 243.

The base 130 of the container 100 provides an extra-wide base for the operator to fill the container 100 without having to manually hold on to the container 100. The wideness of the base 130 allows an overall height for the bottle 50 that lowers a center of gravity of the bottle 50 to improve stability while filling the container 100 and during use.

The outer side surfaces 115 of the container 100 are provided with one or more indentations 140. The indentations 140 provide an ergonomic surface for the user to grip and to hold the bottle 50. The outer side surfaces 115 include the indentations 140 that include an approximately triangular shape. The approximately triangular shape accommodates the curvature of the hand to provide comfortable feeding to the infant or newborn.

The interior volume 125 of the container 100 should be sized to hold approximately 3 to approximately 12 ounces of liquid and also approximately 3 to 6 scoops of measured powder formula. A typical scoop used in formula powder packaging has a volume of approximately 1.0 to approximately 1.3 cubic inches. Many typical dry powder formulas are mixed in a ratio of 1 scoop per 2 fluid ounces of liquid. The embodiment shown in the FIGS. 1-6 accommodates approximately 10.6 ounces of liquid and up to approximately 4 to 6 scoops of power formula. The volume of the container 100 allows for 9 or more ounces of liquid and allows the operator to stir the mixture if needed. The container 100 may also be made shorter or taller to accommodate more or less liquid.

The container 100 may be made from a copolyester BPA free plastic. Other suitable plastics for the container include clarified polypropylene and other BPA free, food safe thermoplastics. The container 100 may made by injection molding a preform and then blow molding the preform. The container 100 may also be made by only using blow molding techniques.

The container 100 may have a height of approximately 2 inches to approximately 8 inches. The container 100 may have an external diameter of approximately 2 inches to approximately 5 inches at the base 130. The container 100 may have an external diameter of approximately 1 ½ inches to approximately 4 inches at the waist 135. The height and width of the container 100 may be scaled up and down depending on the intended volume for the container 100. In the embodiment shown in the FIGS., the opening 210 of the container 100 has a width of at least 2 ½ inches in diameter. The opening 210 of the container 100 may be as wide as the base 130 of the container 100.

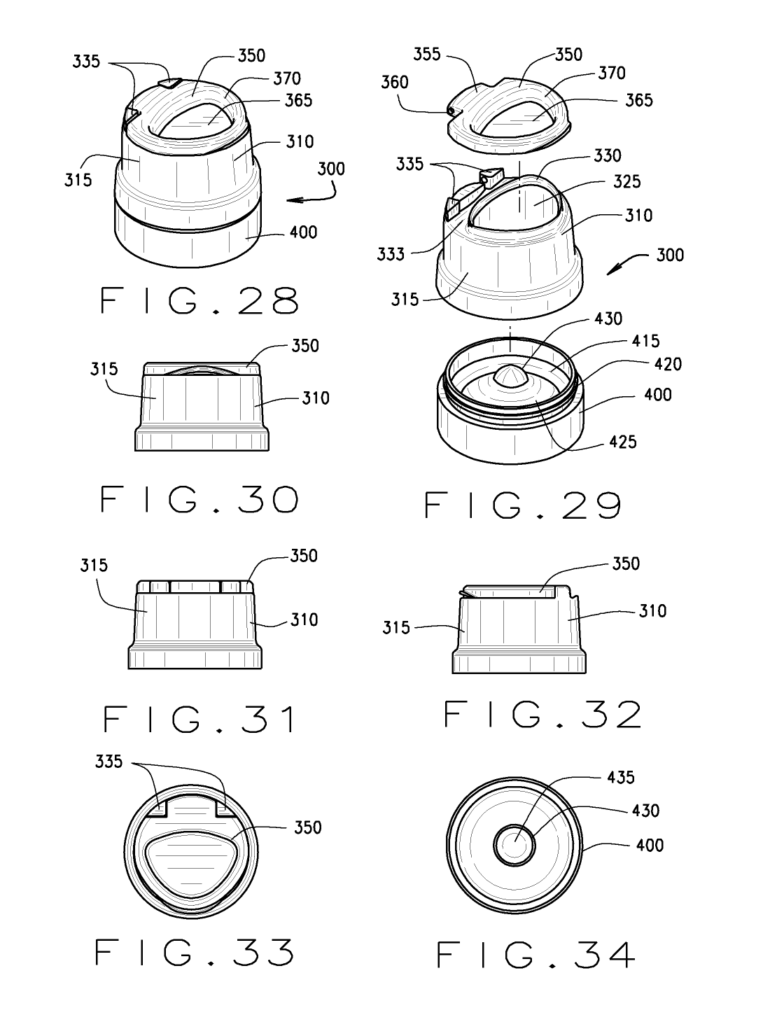

The cap 300 of the bottle 50 will now be described with reference to FIGS. 28-34. The cap 300 defines a powder reservoir 305 to hold multiple scoops of dry powder formula. When it is desired to use the formula contained in the powder reservoir 305, a lid 350 is opened from the cap 300, and the formula is poured into the container 100. Importantly, the cap 300 maintains the powder reservoir 305 in an attachment or removable connection to the bottle 50. Specifically, the cap 300 snaps to the clamp ring 500. As such, the bottle 50 maintains its liquid in the container 100 and the dry formula in the cap 300, which is attached to the bottle 50.

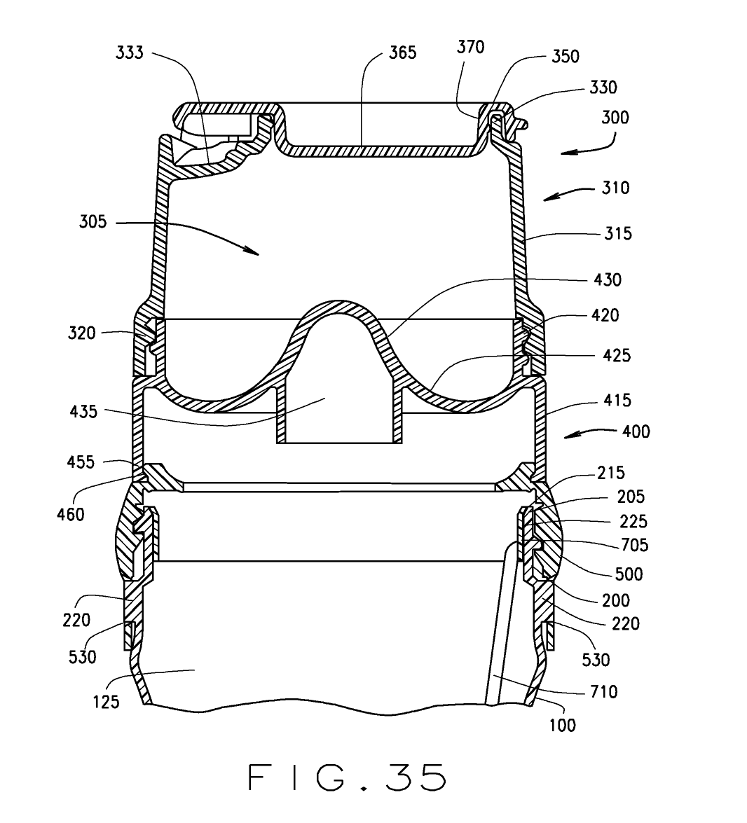

As shown in FIG. 29, the cap 300 includes an upper portion 310 and a bottom portion 400. The combination of the upper portion 310 and the bottom portion 400 form the powder reservoir 305. As shown in FIG. 35, the upper portion 310 includes threaded portions 320 that threadably engage threaded portions 420 of the bottom portion 400. The upper portion 310 may be completely separated from the bottom portion 400. As such, the cap 300 may be completely disassembled in order to facilitate cleansing.

The upper portion 310 includes sidewalls 315 that are integral to or transition into a top surface 333. The top surface 333 defines an opening 325 that allows the powder to fill and to pour from the powder reservoir 305. The opening 325 further includes opening rim walls 330. The lid 350 includes hinge portions 355 that are hingedly connected to hinge members 360 of the upper portion 310. The lid 350 includes a depressed portion 365 defined by descending walls 370. The descending walls 370 seal against opening rim walls 330 when the lid 350 is snapped to a closed position. The upper portion 310 has an essentially open lower portion. The bottom portion 310 forms a bottom surface for the powder reservoir 305.

The upper portion 310 and the bottom portion 400 may be made from a polypropylene plastic. The upper portion 310 and the bottom portion 400 may also be made from other food safe, thermoplastics.

The bottom portion 400 includes first side that is a containment surface 425 that extends generally perpendicular to sidewalls 415. As such, the sidewalls 315 of the upper portion 315, in conjunction with the containment surface 425, form the power reservoir 305. The sidewalls 415 form an outer generally circular structure to the cap 300.

The containment surface 425 includes a nipple receiving portion 430 defining a nipple volume 435. The nipple receiving portion 430 extends upwardly from the containment surface 425. As such, the powder reservoir 305 is generally positioned above the nipple 600, with an outer surface of the nipple receiving portion 425 extending partially into the powder reservoir 305.

The nipple receiving portion 430 has a shape complementary to the extending portion 610 of the nipple 600. When the cap 300 is engaged over a bottle 50, the nipple 600 extends into the nipple receiving portion 430. The receiving portion 430 maintains and prevents the nipple 600 from contacting other surfaces or structures that would cause the nipple 600 to leak. Also, cap 300 serves to prevent the nipple 600 from contacting dirt and other contaminants. When it is time to mix the formula with the liquid in the container 100, the clamp ring 500 may be disengaged from the container 100 with the cap 300 still connected to the clamp ring 500. As such, the nipple 600 remains covered by the cap 300. The operator may then pour the dry powder formula from the cap 300 into the container 100, and then replace the clamp ring 500 onto the container with the cap 300 still connected to the clamp ring 500. The bottle 50 may then be shaken or stirred, while the nipple 600 is still covered by the cap 300.

As shown in FIG. 35, a first side of the bottom portion 400 that attaches to the rest of the baby bottle 50 includes a rim 455 defining an internal diameter 460. The rim 455 snaps to the clamp ring 500.

A second side of the bottom portion 400 that attaches to the upper portion 310 includes the sidewalls 315 of the upper portion 310, which include its threaded portion 320 on an interior portion of the sidewalls 315. The sidewalls 415 of the bottom portion 400 include its threaded portion 420 on an exterior portion of the sidewalls 415. The sidewalls 415 taper inward at the threaded portion 420. As such, the assembled cap 300 provides a smooth exterior surface.

The cap 300 holds approximately 4 to 8 cubic inches of dry powder formula in its powder reservoir 305. Importantly, the dry powder formula is maintained separately from the liquid in the container 100. Further, the cap 300 provides the convenience of having the dry powder formula connected or attached to the baby bottle 50. The operator does not have to search through a diaper bag or the like looking for both a bottle and a container holding formula. The cap 300 may also be used to store dry powder formula separate from the bottle 50. As such, the cap 300 provides a storage container for dry powder formula.

The clamp ring 500 will now be described with reference to FIGS. 18-22. The clamp ring 500 threadably engages to the threaded portions 235 of the container 100. The clamp ring 500 forms a flange 510 that defines a nipple opening 505. As shown in FIG. 26, the flange 510 urges against a perimeter portion 625 of the nipple 600 when the clamp ring 500 is engaged to the container 100. The clamp ring 500 includes an outer surface 515 which includes a gripping surface 520. The outer surface 515 further includes sidewalls 525 that define one or more apertures in the form of windows or openings 530.

The nipple 600 provides for the bottle 50 to vent. A perimeter portion 625 of the nipple 600 defines or includes a valve 635. The valve 635 allows air to enter the container 100 in order to prevent a vacuum from forming in the interior 125 of the container 100. Liquid in the container 100 generally does not leak from or pass through the valve 635, since the valve 635 remains closed until a sucking or drinking pressure is applied to the nipple 600. As shown in FIG. 16, the valve 635 is positioned in a recess 630 of the perimeter portion 625 of the nipple 600. The valve 635 includes a top opening 640 and bottom opening 645. The top opening 640 and the bottom opening 645 are connected by angled walls 648. As the child sucks or drinks from the container 100, the force or pressure causes the nipple 600 to collapse inward and to break the seal of the valve 635. The angled walls 648 of the valve 635 separate to cause the valve 635 to open to allow air to enter the container 100 to replace the liquid that has been drunk from the container 100. Other nipples with different or similar valves and/or venting structures may be used with the baby bottle 50 described herein.

The clamp ring 500 further includes an inner surface 535 that forms the threaded portion 540. The clamp ring 500 provides for a secure engagement to the container 100. The clamp ring 500 locks to the container 100 via an approximately 180 degree turn. As such, a user may securely attach the clamp ring 500 to the container 100 with a simple, single turn of the wrist. This allows the operator to securely close the bottle 50 without over-tightening the clamp ring 500 or under-tightening the clamp ring 500.

The engagement of the clamp ring 500 to the container 100 provides an audible click, as well as a detent or snap feel, when the clamp ring 500 is properly secured to the container 100. As shown in FIG. 22, the threaded portion 540 terminates in a thread end 555. The thread end 555 further includes a radially and axially extending contact surface 560 that faces in a circumferential direction. The threaded portion 540 also includes a projecting member 550 that extends radially inwardly from the sidewall 525. An inner surface of the projecting member 550 is substantially flush with the portion of the sidewall 525 from which the threaded portion 540 extends. Also, the projecting member 550 is circumferentially spaced from the contact surface 560 of the threaded portion 540 as indicated at 545. As shown in FIG. 10, the threaded portions 235 of the outer neck surface 230 include a radially outwardly projecting stop member 240. The stop member 240 includes radially and axially extending stop surfaces 245 that face in a circumferential direction, and a first portion 243 having a first radial height and a second portion 247 having a second radial height. When the clamp ring 500 is being engaged with the container 100, the projecting member 550 on the inner surface 535 of the clamp ring 500 passes over the higher second portion 247 of the stop member 240 of the outer neck surface 230. After the projecting member 550 passes over the stop member 240, the contact surface 560 of the thread end 555 is moved circumferentially into engagement with the stop surface 245 of the first portion 243 of the stop member 240 to thereby prevent further tightening of the clamp ring 500. As such, the bottle 50 reduces the likelihood of over-tightening. As the projecting member 550 slides over the top of the stop member 240, the projecting member 550 is urged away from the outer neck surface 230.

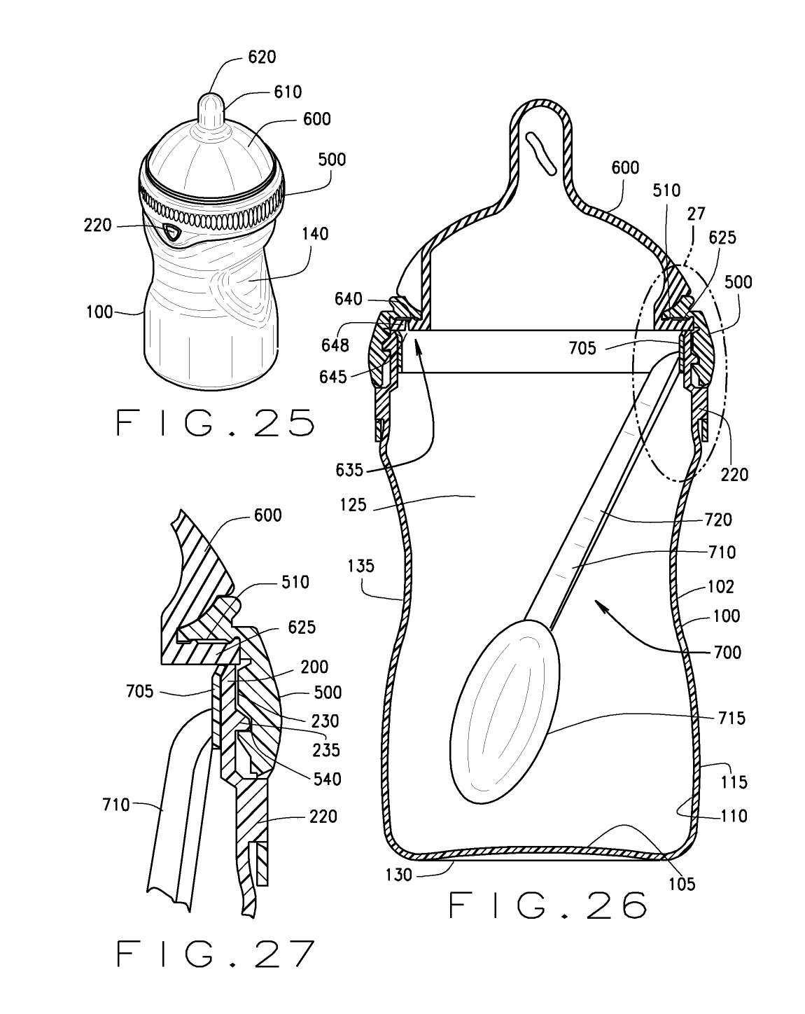

The clamp ring 500 is generally made from a more flexible material than the outer neck surface 230 and/or the container 100. As such, the clamp ring 500 deforms, bends, and/or expands to allow the projecting member 550 to pass over the stop member 240. When the projecting member 550 clears the stop member 240, the projecting member 550 snaps back to the outer neck surface 230 creating the audible clicking or snapping sound. In this regard the projecting member 550 and the stop member 240 cooperate to define a detent engagement feature for securing the clamp ring 500 to the container 100. The deforming and resilient nature of the clamp ring 500 provides for its ability to expand over the stop member 240 and retract against the outer neck surface 230. As shown in FIG. 24, at this point, the stop member 240 is now positioned between the projecting member 550 and the thread end 555 generally in the space 545 defined therebetween. The clamp ring 500 cannot be successfully tightened any further as the vertical contact surface 560 of the thread end 555 is pressing against the lateral surfaces 245 of the stop member 240. Moreover, because unscrewing the clamp ring 500 requires moving the projecting member 550 back over the higher second portion 247 of the stop member 240, accidental unscrewing of the clamp ring 500 is reduced. In some embodiments, the projecting member 550 is provided with angled cam surfaces that help the projecting member 550 ride up and over the stop member 240 during attachment and detachment of the clamp ring 500 from the container 100.

As shown in FIGS. 8-10, the threaded portion 540 includes two threads. A first thread 237 and a second thread 239 each extend approximately 180 degrees around the opening 210. The first thread 237 ends in a first stop member 242, and the second thread 239 ends in a second stop member 244. The first stop member 242 is opposite of the second stop member 244.

By engaging limiting rotation of the clamp ring 500 relative to the container 100 as discussed above, the thread end 55 and the stop members 240 cooperate to ensure the proper amount of axial pressure or closing force is applied to the nipple 600. As such, the bottle 50 is properly closed. With the correct amount of pressure or closing force between the nipple 600, the container 100, and the clamp ring 500, the valve 635 operates properly to equilibrate with the atmosphere and reduces the likelihood of a vacuum forming in the interior of the container 100. Further, the nipple 600 is properly closed or sealed to the container 100 by the clamp ring 500 to prevent spillage or leakage. Additionally, the bottle 50 is difficult, if not impossible, to over-tighten, since such would strip or break the stop member 240 or the threaded portion 240.

The locking indicator will now be described with particular references to FIG. 39. The outer neck surface 230 of the upper portion 155 includes an indicator portion 220. The indicator portion 220 may include one or more of a region of different color, a member that extends from the container 100, a texture on the surface of the outer neck surface, or other shape or design on the exterior of the container 100.

When the clamp ring 500 is fully locked to the container 100, the window 530 is positioned over the indicator portion 220 such that the indicator portion 220 is viewable through the window 530. This provides a visual signal to the operator that the clamp ring 500 is fully or correctly engaged to the container 100. Such provides reassurance to the operator of the proper engagement of the nipple 600, clamp ring 500, and container 100 so that leaking and/or vacuum problems are less likely to occur.

The window 530 may be formed in the sidewalls 525 of the clamp ring 500. The window 530 may be positioned just below the gripping surface 520. One or more windows 530 may be formed by the clamp ring 500. The window 530 may have a complimentary shape to the indicator portion 220. The indicator portion 220 may include a shape that projects from the container 100, and the window 530 receives the projecting shape when the clamp ring 500 is fully engaged to the container 100. As the clamp ring 500 is rotated to the proper engagement, the indicator portion 220 comes into view through the window 530.

The clamp ring 500 may be made from a polypropylene plastic. Other food safe, thermoplastic may be used for the clamp ring 500.

The stifling insert 700 will now be described. The stirring insert 700 improves the blending of the formula with the liquid. The time it takes to thoroughly mix the dry powder formula with the liquid may be reduced by using the stirring insert 700. The use of the stirring insert 700 may reduce colic and other digestive problems, as the use of the stirring insert 700 may reduce the number of air bubbles in the formula. The stifling insert 700 may also be used to mix expressed breast milk in the container 100. The stifling insert 700 may be optionally used with the container 100.

The stirring insert 700 may be maintained in the container 100 after blending of the formula and while the child is drinking from the container 100. The stirring insert 700 generally includes a support member in the form of a collar or ring shaped member that fits into the opening 210 of the container 100. An elongate member or mixing member is attached or integral to the collar or ring shaped member. The elongate member extends down into the container 100 and at least partially across the interior of the container 100. The elongate member moves to mix or blend the formula.

With reference to FIGS. 12-14, the stifling insert 700 includes support member in the form of an inner collar 705 that is attached to or integral with a paddle portion 710. The paddle portion 710 includes a connection portion 725 that connects or attaches to the inner collar 705. From the attachment portion 725, the paddle portion 710 forms a narrow portion 720 that is integral with or leads into a broad portion 715. The stifling insert 700 is placed into the interior volume 125 of the container 100. The inner collar 705 is held in position at the opening 210 of the neck portion 200. Specifically, the inner neck surface 225 of the neck portion 200 holds the inner collar 705. The inner neck surface 225 includes a slight narrowing in inner diameter that holds the inner collar 705 and reduces the likelihood of the inner collar 705 falling completely into the container 100. When the inner collar 705 is positioned in the neck portion 200, the narrow portion 720 extends into and through the interior volume 125 such that the broad portion 715 is positioned in a lower half of the interior volume 125.

The paddle portion 710 is generally fixed to the inner collar 705. The paddle portion 710 moves back and forth relative to the inner collar 705. Specifically, the narrow portion 720 bends and flexes to allow the broad portion 715 to move back and forth to help mix the formula and the liquid.

The broad portion 715 is positioned above the inner bottom surface 105 of the container 100. When the formula powder and the liquid are placed into the container 100, the stirring insert 700 assists in mixing the formula and the liquid. When the bottle 50 is shaken, the stirring insert 700 oscillates or moves in a back-and-forth manner to mix the formula with the liquid. The stirring insert 700 forms whirlpools and eddies in the liquid contents of the container 100 to mix the formula with a liquid. The stifling insert 700 may reduce the formation of air bubbles in the liquid which may prove problematic to the digestion of certain children.

The narrow portion 720 allows the broad portion 715 to move back and forth. The narrow portion 720 bends and flexes as the broad portion 715 moves. The broad portion 715 is generally thicker and wider than the narrow portion 720.

The inner collar 705 is generally formed of a more rigid material than the paddle portion 710. The paddle portion 710 may be formed or molded from a silicone-type material. The stirring insert 700 may be formed from a silicone material having a 60 durometer. Other silicones with a durometer of approximately 50 to approximately 70 may be suitable. The silicone material used in forming the stirring insert 700 should have sufficient rigidity to return to its original position after the shaking or the stirring has stopped.

The stifling insert 700 provides for improved blending or mixing of the liquid and the dry powder formula. If the operator is using a stifling or rotating technique in which the bottle is moved or rotated in a circular pattern, the stifling insert 700 will mix the liquid and formula in less time and with less clumps, as the whirlpools and eddies in the liquid assist in blending. The use of the stifling insert 700 in the stirring or rotating techniques does not create or form additional air bubbles as compared to stifling or rotating the bottle without the stifling insert. If the operator is vigorously shaking the bottle 50 in order to mix its contents, the use of stirring insert 700 will provide for faster mixing without forming additional air bubbles as compared to shaking the bottle 50 with no insert 700. The stirring insert 700 improves the mixing or blending of baby formula that generally consists of a high fat emulsion of proteins. The stifling insert 700 may mix or blend the formula and liquid with reduced gas bubbles resulting in better digestion and health for the child. The stifling insert 700 may be scaled larger and smaller for use with different sized containers 100.

In certain embodiments, the stifling insert 700 may be formed by a co-molding process that forms the inner collar 705 from a first material, while forming the paddle portion 710 from a second material. The inner collar 705 may be made from clarified polypropylene or other food safe thermoplastic.

In the embodiment in FIGS. 12-14, the stifling insert 700 is an integral structure. However, as described below, the attachment portion 725 may include a food safe adhesive or other mechanical attachment between the paddle portion 710 and the inner collar 705.

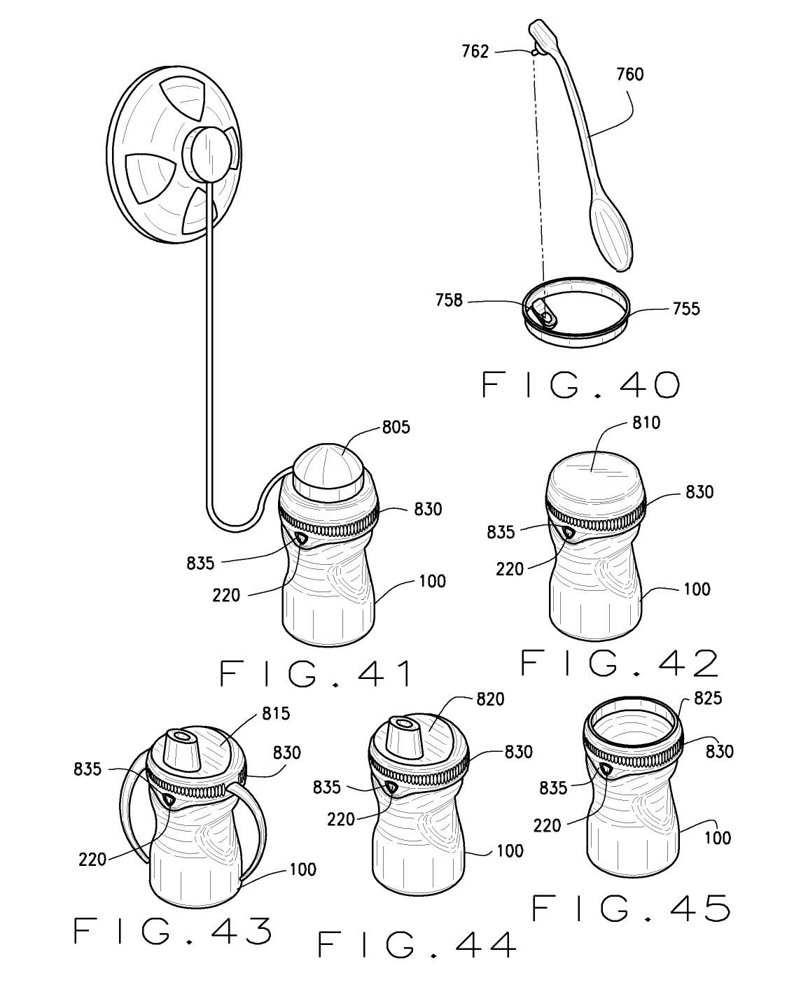

A two-piece embodiment of a stirring insert 750 is shown in FIG. 40. An inner collar 755 attaches or connects to the paddle portion 760. The inner collar 755 forms or defines an opening 758 that receives an insert portion 762 of the paddle portion 760. A food safe adhesive may be used to attach or connect the paddle portion 760 with the inner collar 755. A mechanical connection may also be used to attach or connect the paddle portion 760 with the inner collar 755. The insert portion 762 may crimp to the opening 758 or the insert portion 762 may form a flanging connection that inserts into the opening 758.

The bottle 50 may also be used with a conventional over cap 900 or the cap 300. The over cap 900 connects to the clamp ring 500 to contain the nipple 600.

A system cup 800 is shown in FIGS. 41-45. A single container 100 has different lids or tops that attach to the container 100 for use during the period from newborn to adolescence. Thus, a single cup may be used throughout that time period. The container 100 is connectable with a breast milk pump attachment lid 805, a storage lid 810, a sippy lid with handles 815, a sippy lid 820, and a rim 825. The system cup 800 promotes familiarity and encourages drinking and/or feeding. As the same container 100, may be used throughout infancy, childhood, or adolescence, the child may adapt better to switching from a nippled bottle to a handled sippy cup, and further adapt better from a handled sippy cup to a sippy cup, and further adapt better from the sippy cup to a rimmed cup. The child may find comfort in using the same container 100 as part of drinking, and the child may adapt easier to drinking from the container 100 with the sippy lid 820, since the child may have already been drinking or feeding the container 100 with the nipple 600. Further, the child may be familiar with holding the container 100, and thus develop coordination and muscle memory to continue to hold and drink from the container 100.

The breast milk pump attachment lid 805 allows for the container 100 to receive breast milk directly from the breast. As such, a single container 100 may be used to receive the breast milk, store the breast milk, and then be used in the feeding of the child. The storage lid 810 may connect to the container 100 to provide storage of the breast milk in the refrigerator. When it is time for feeding, the storage lid may be removed from the container 100 and replaced with the nipple 600 and clamp ring 500. The storage lid 810 may also be used with other liquids in the container 100, to provide spill-proof storage for the liquid in the container 100.

The sippy lids 815 and 820 provide for the container 100 to be used as a sippy cup. The rim 825 provides for the container 100 to be used a drinking cup. The rim 825 provides a smooth surface that covers up the threaded portion 235 on the outer neck surface 230.

The system cup 800 allows for a single cup or a single type of cup to be used throughout childhood. Instead of buying and maintaining a supply of different cups that are all suited for a different purpose and/or age range, the parent or caregiver could solely use the system cup 800. As such, the container portions of the baby bottles are not outgrown by the child when the child moves to a sippy cup or regular drinking cup. The same container portion may be continually used throughout childhood.

Further, the container 800 may be given to the child with the rim 825 in place for drinking. Should the child desire to save the drink for later, the rim 825 may be removed and replaced with the storage lid 810 for placing the container 100 in the refrigerator. Alternatively, the rim 825 may removed and replaced with the sippy lid 815 for drinking while in the car or the like.

Each of the breast milk pump attachment lid 805, the storage lid 810, the sippy lid with handles 815, the sippy lid 820, and the rim 825 may include sidewalls 830 that form or define an opening or window 835 to operate in conjunction with the indicator portion 220 on the container 100. Further, each of the breast milk pump attachment lid 805, the storage lid 810, the sippy lid with handles 815, the sippy lid 820, and the rim 825 may include an inner surface with threaded portions and a projecting member to providing the positive locking indication of the clamp ring 500.

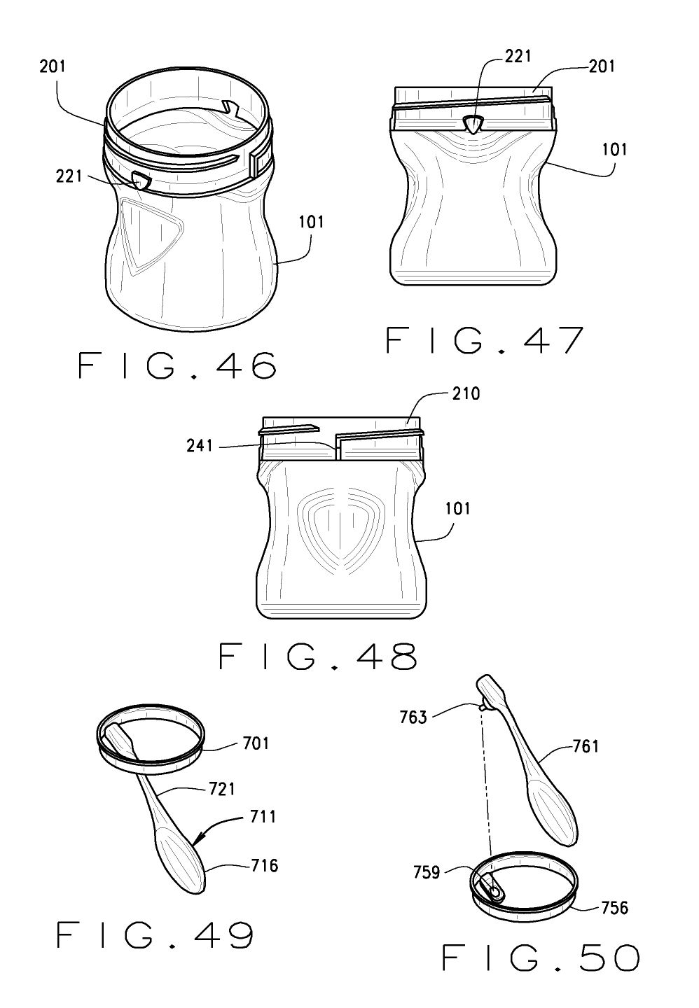

A second container 101 is shown in FIGS. 46-48. The second container 101 is configured to hold a smaller volume than the container 100. The second container 101 is shorter to accommodate the smaller volume. Newborns and infants may only require several ounces of formula or breast milk per feeding. As such, the container 101 holds approximately 4 ounces of fluid with additional volume to accommodate several scoops of formula and to allow mixing.

Importantly, the container 101 has a neck portion 201 that is similar or identical to the neck portion 200. This allows the second container 101 to be used with the same clamp ring 500 and nipple 600 as the container 100. The second container 101 may also be used with the same breast milk pump attachment lid 805, the storage lid 810, the sippy lid with handles 815, the sippy lid 820, and the rim 825. As such, all of said lids may be used interchangeably between the container 100 and the container 101. A parent may use the clamp ring 500 and the nipple 600 on the container 101 when the child is a newborn, and then the parent may use the same clamp ring 500 and the nipple 600 on the container 100 when the child grows and has an increased demand for formula, breast milk, regular milk, etc.

The container 101 includes a stop portion 241 to provide the same operation and benefits of the stop portion 240 on the container 100. Namely, the container 101 may be closed with a 180 degree turn with the clicking feel and audible sound. The container 101 further includes an indicator portion 221 to provide the visual signal that the container 101 has been properly closed.

Additional stir inserts are shown in FIGS. 49 and 50 and are suitable for use with the container 101. FIG. 49 shows an integral stir insert with an inner collar 701 and a paddle portion 711. A narrow member 721 connects to a broad portion 711. The narrow member 721 is shorter in length compared to the narrow member 720 shown in FIG. 12 in order to fit into the shorter container 101. FIG. 50 shows a two-piece insert. Paddle portion 761 attaches to an insert portion 759 of an inner collar 756. An insert portion 763 attaches or connects to an opening 759.

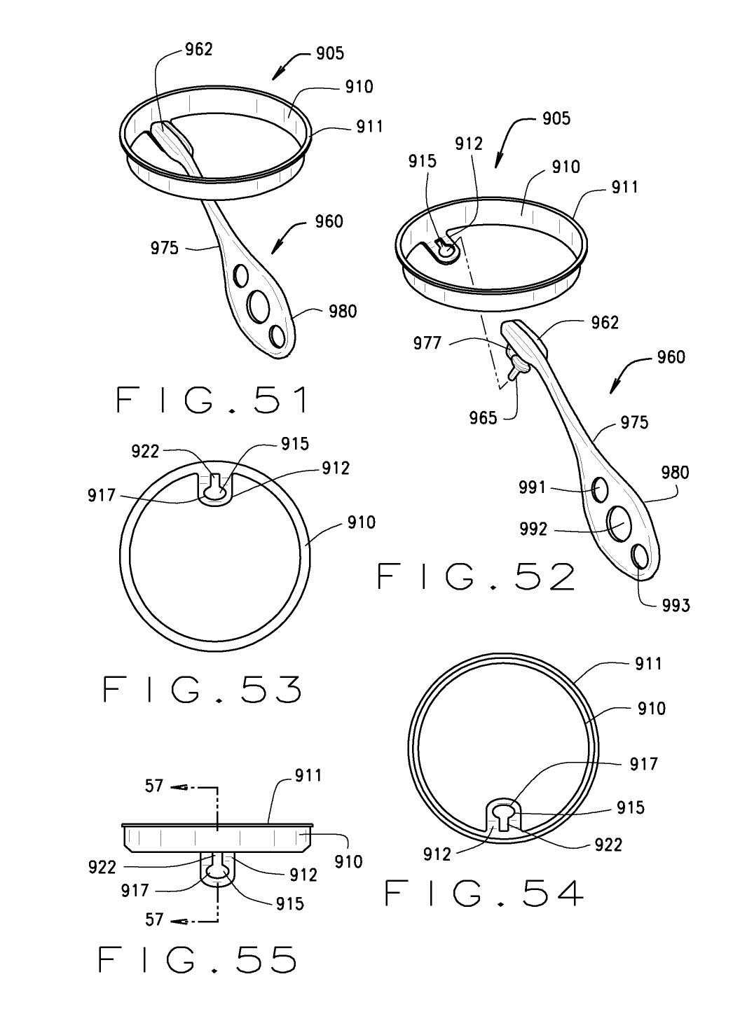

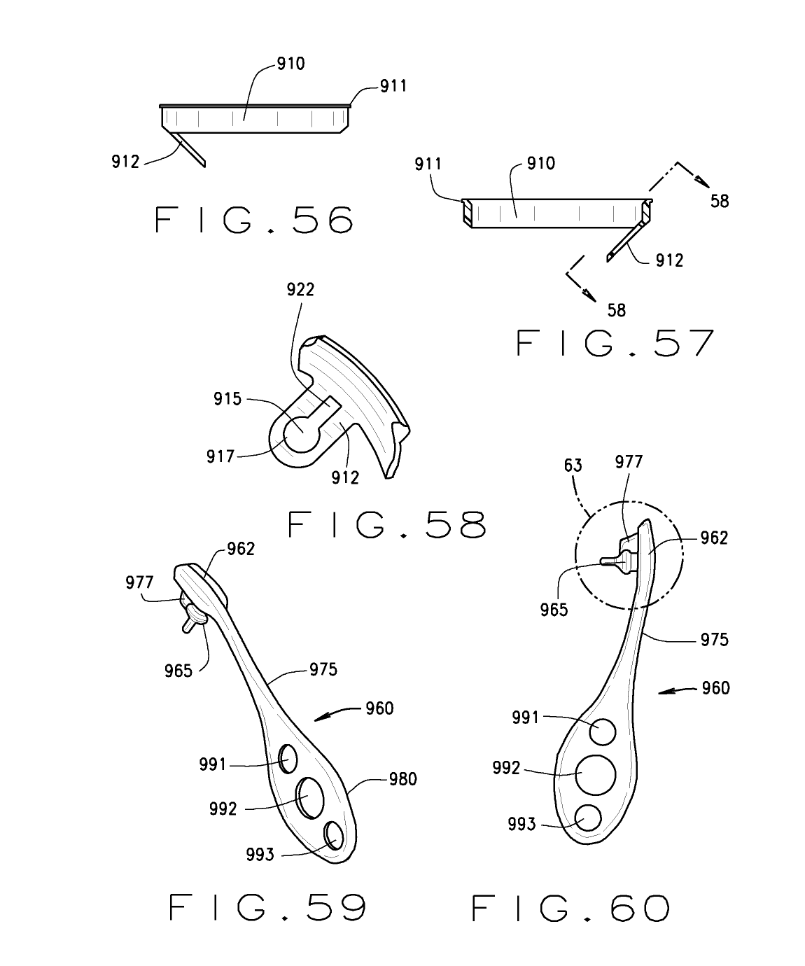

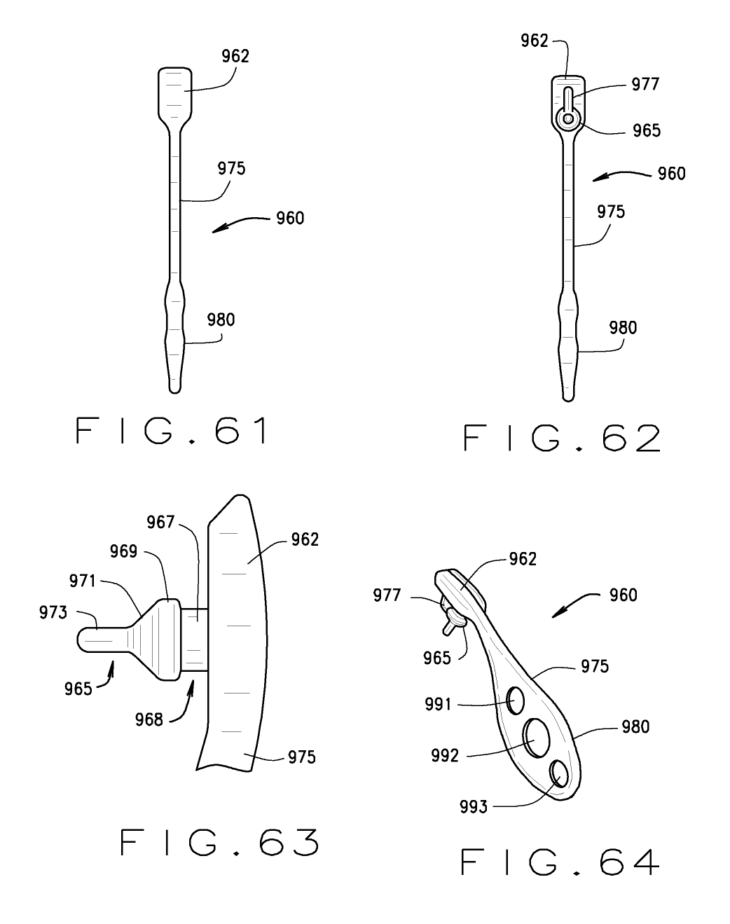

A second two-piece embodiment of a stifling insert 905 is shown in FIGS. 51-64. As with other embodiments, the stifling insert 905 improves the blending of the formula with the liquid, as it may reduce the time required to thoroughly mix the formula with the liquid and reduce the number of air bubbles in the formula. The stirring insert 905 includes a paddle portion 960 that connects to an inner collar 910.

The inner collar 910 includes a circular ring shaped member that fits into or on the opening 210 of the container 100. The paddle portion 960 extends from the inner collar 910 down into the container 100 and at least partially across the interior of the container 100. Generally, an upper end 962 of the paddle portion 960 connects to the inner collar 910 and remains stationary while the remainder of the paddle portion 960 moves to mix or blend the formula in the container 100.

The upper end 962 of the paddle portion 960 connects or attaches to the inner collar 910 using a flanging connection that securely holds the upper end 962 of the paddle portion 960 to the inner collar 910. The inner collar 910 forms or defines an opening 915 that receives an insert portion 965 of the upper end 962 of the paddle portion 960. The insert portion 965 inserts into the opening 915 to form a mechanical connection between the paddle portion 960 and the inner collar 910. The insert portion 965 forms a flanging connection that inserts into the opening 915 to firmly and securely hold the paddle portion 960. When sufficient manual force is applied, the insert portion 965 may be removed from the opening 915. The paddle portion 960 is generally fixed to the inner collar 910 by the flanging connection provided by the insert portion 965 inserting into the opening 915. The paddle portion 960 moves back and forth relative to the inner collar 910.

From the insert portion 965, the paddle portion 960 forms a narrow portion 975 that is integral with or leads into a broad portion 980. The narrow portion 975 of the paddle portion 960 bends and flexes to allow the broad portion 980 to move back and forth to help mix the formula and the liquid. The broad portion 980 is generally thicker and wider than the narrow portion 975.

The broad portion 980 may include or define one or more openings. The one or more openings may have the same or different sizes. As shown in FIG. 64, the broad portion 980 includes openings 991, 992, and 993. In this embodiment, the opening 992 has a larger circumference than the openings 991 and 993. In other embodiments, the openings 991, 992, and 993 may all have the same circumference. The openings 991, 992, and 993 pass completely through the broad portion 980. A portion of the fluid and/or formula may pass through any of the openings 991, 992, and 993.

With reference to FIG. 63, the insert portion 965 includes a shape and structure to hold and connect with the opening 915 of the insert collar 910. The insert portion 965 includes a shaft 967 extending from the upper end 962 of the paddle portion 960. The shaft 967 transitions into a widened portion 969. The widened portion 969 includes a tapered portion 971 that transitions into a protruding portion 973. Generally, the protruding portion 973 will have a narrower circumference as compared to the tapered portion 971.

A wall 977 or other narrow structure is also integrally connected or closely positioned to the widened portion 969 and/or the shaft 967. The wall 977, in conjunction with the shaft 967 and the widened portion 969, forms a t-shaped structure or fixture that engages to complementary structures of the opening 915. The wall 977 may extend from the upper end 962 of the paddle portion 960 adjacent the insert portion 965.

The opening 915 is formed in a tab 912 of the insert collar 910. The tab 912 extends from the inner diameter of the insert collar 910. As shown in FIG. 57, the tab 912 may be positioned at or near a bottom edge of the inner collar 910. The tab 912 may angle toward a center of the insert collar 910.

As shown in FIG. 58, the opening 915 includes a wide opening portion 917 and a narrow opening portion 922. The opening 915 form a “t” shape. The wide opening portion 917 transitions or narrows to form the narrow opening portion 922. The narrow opening portion 922 forms a slot, channel, or other elongate opening to receive the wall 977. The wide opening portion 917 has a larger or wider opening than the narrow portion 922. The wide opening portion 917 may include a circular, round, ovular, rectangular, or other wide-shaped opening.

The wide opening portion 917 receives the protruding portion 973, the tapered portion 971, and the widened portion 969. The outer diameter of the widened portion 969 squeezes through the wide opening portion 917 and is lockingly held in place as the sides of the wide opening portion 917 are in an annular notch 968 between the widened portion 969 and a back of the upper end of the paddle portion 962 and around the shaft 967. When desired by the user, the widened portion 969 may be pulled from the wide opening portion 917 to disassemble the stifling insert 905.

The stirring insert 905 is placed into the interior volume 125 of the container 100. The inner collar 910 is held in position at the opening 210 of the neck portion 200. The inner collar 910 includes a circumferential lip 911 around its outer periphery. The circumferential lip 911 rests against the inner neck surface 225 that includes the slight narrowing in inner diameter that holds the stirring insert 905.

The broad portion 960 is positioned above the inner bottom surface 105 of the container 100. When the formula powder and the liquid are placed into the container 100, the stirring insert 905 assists in mixing the formula and the liquid. When the bottle 50 is shaken, the stirring insert 905 oscillates or moves in a back-and-forth manner to mix the formula with the liquid. The stirring insert 905 forms whirlpools and eddies in the liquid contents of the container 100 to mix the formula with a liquid. The openings 991, 992, and 993 may improve the mixing or stirring. The stifling insert 905 may reduce the formation of air bubbles in the liquid which may prove problematic to the digestion of certain children.

The inner collar 910 may be made from polypropylene, such as clarified polypropylene, or other food safe thermoplastic. The paddle portion 960 may be formed or molded from a silicone-type material. The paddle portion 960 may be formed from a silicone material having a 75 durometer.

As shown in FIG. 64, the paddle portion 960 may be provided in a reduced size to fit smaller containers.

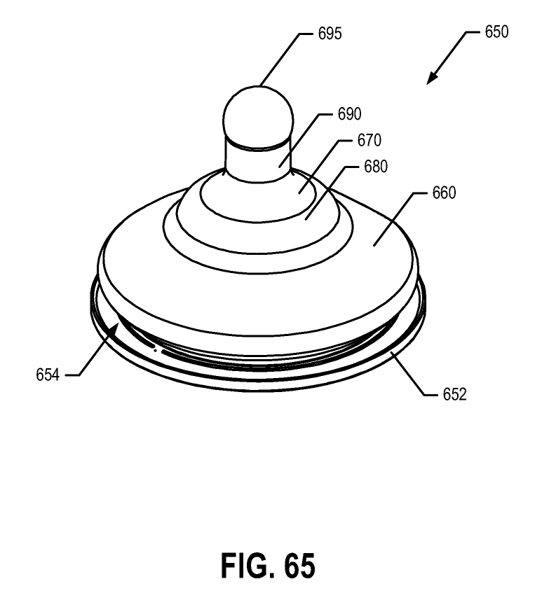

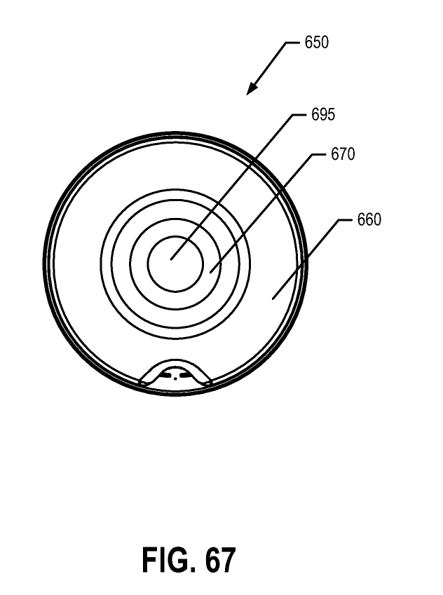

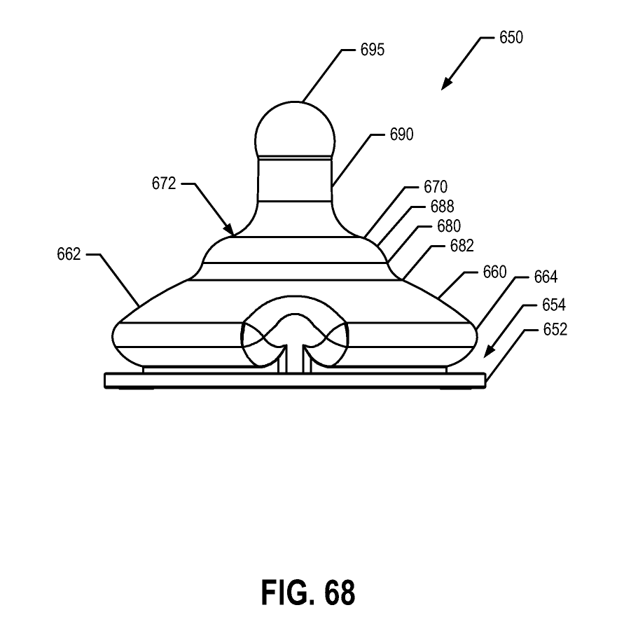

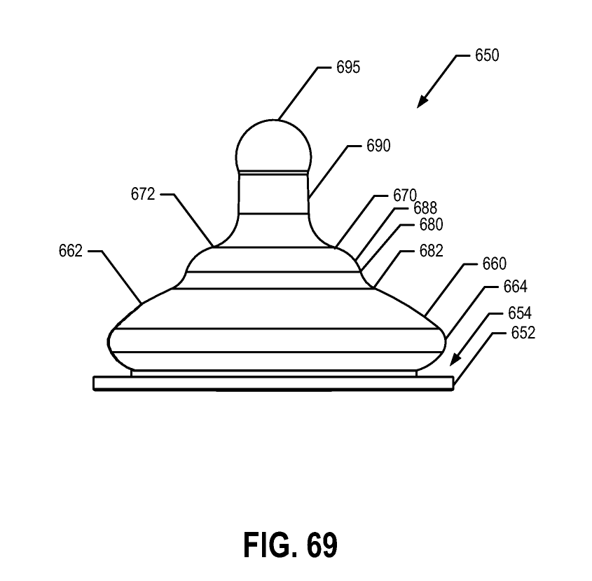

FIGS. 65-69 illustrate another embodiment of a nipple 650 for use with the baby bottle 50. The nipple 650 includes a base 660 and a raised section 670. The base 660 is integral with the raised section 670. The raised section 670 further includes a shaft 690 extending or protruding from the raised section 670. The shaft 690 includes a nipple opening 695 for the passage of fluid from the interior of the bottle or container to the mouth of the baby.

The base 660 and the raised section 670 are integrally connected by a wall 680. The base 660 includes a base surface 662 that transitions at a first transition point 682 into the wall 680. The wall 680 transitions into the raised section 670 at a second transition point 688. The wall 680 connects the base 660 and the raised section 670. The base surface 662 generally curves or slopes upward to the wall 680. The wall 680 generally raises or extends from the base surface 662 to join the raised section 670. The raised section 670 generally curves or slopes upward to join with the shaft 690.

The wall 680 may have a generally curved or generally straight shape to connect the base 660 and the raised section 670. The base surface 662 and the raised section surface 672 may both form a sloping surface increasing in height toward the shaft 690.

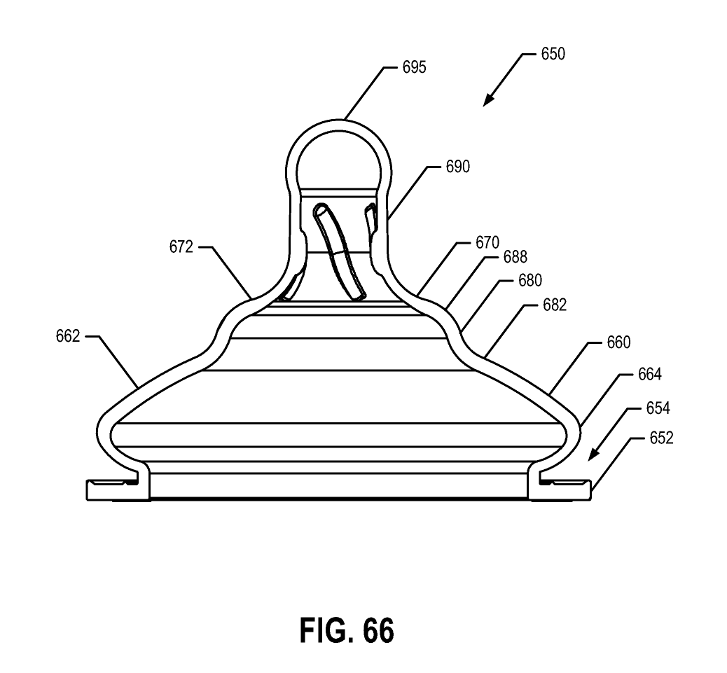

The base surface 662 and the raised section surface 672 are spaced apart. The wall 680 separates the base surface 662 and the raised section surface 672. Further, the raised section 670 has a smaller diameter than the base 660. When drinking from a container having the nipple 695, the baby's mouth generally seals against the raised section 670 and/or the shaft 690. As such, a gap or space is formed between the baby's face or nose and the outer surface of the nipple 695. The space is generally above the base 660 and to the side of the raised section 670 as viewed in FIG. 66, 68, or 69.

The raised section 670 is generally positioned in the middle of the base 660. The raised section 670 has generally circular shape raising or elevating from the base 660. The base 660 also has a generally circular shape.

The nipple 650 may be formed from conventional nipple-forming materials, such as silicone.

The nipple 650 further includes a perimeter 652 that forms a groove 654 between the perimeter 652 and an outer circumference 664 of the base 660. The groove 654 receives a flange of a clamping ring that is used to seal the nipple 695 against the container.

Thus, in general, the nipple 650 includes a raised structure, such as a raised section, collar, ridge, or the like that is positioned on or integrated with a base of the nipple. The raised structure and the base assist the baby drinking from a bottle. The raised structure is elevated or raised from a surface of the base. This provides a space for the baby to drink from the bottle without the nipple or top of the bottle obstructing or interfering with the baby's nose or face. When the baby drinks from the bottle using the nipple, the baby's mouth seals against the raised structure and/or the shaft, while the baby's nose or face is separated from the base. This arrangement between the raised structure and the base provides airflow to the baby's nose while the baby's mouth is sealed against the raised section and/or shaft. Other narrower bottles and drinking containers generally position the baby's nose away from the top surface of a nipple or the bottle, as their diameter is narrower.

The nipple 650 is suitable for use with baby bottles or other drinking containers having a wide mouth or an increased diameter. For example, the nipple is well suited for use with containers having a diameter of greater than approximately 2 inches.

It should be understood from the foregoing that, while particular embodiments of the invention have been illustrated and described, various modifications can be made thereto without departing from the spirit and scope of the present invention. Therefore, it is not intended that the invention be limited by the specification; instead, the scope of the present invention is intended to be limited only by the appended claims.

1-99. (canceled)

100. A baby bottle comprising:
a container including a rim that defines an opening the container further including sidewalls extending from the rim to a bottom to define an interior for the container; and
a stirring member including a ring shaped support collar supported by the rim, the ring shaped support collar comprising a tab extending radially inward toward the central axis of the container, the stirring member further comprising a paddle having an elongate shape coupled to the tab and extending from the tab at an angle with respect to the central axis of the container through the interior toward the central axis of the container, wherein the paddle is flexible and moves back and forth when the baby bottle is shaken.

101. The baby bottle of claim 100, wherein the paddle extends from a location adjacent the rim downwardly into the container, and wherein a distal end of the paddle is positioned in a lower half of the interior of the container.

102. The baby bottle of claim 101, wherein the paddle has a narrow portion proximal the rim and a broad portion defining the distal end of the paddle member.

103. The baby bottle of claim 102, wherein the broad portion defines an opening.

104. The baby bottle of claim 102, wherein the paddle is detachably coupled to the tab.

105. The baby bottle of claim 104, wherein the support collar extends around an inner surface of the rim.

106. The baby bottle of claim 104, wherein the support collar is a relatively rigid material and wherein the paddle is a relatively flexible material.

107. The baby bottle of claim 106, wherein the support collar is a thermoplastic material and the paddle is a silicone material.

108. The baby bottle of claim 101, wherein the paddle extends from the location adjacent the rim and across the center of the container.

109. The baby bottle of claim 100, further comprising a nipple and a clamp ring securing the nipple to the container, and wherein the stirring member is secured to the rim by the clamp ring.

110. A stir insert for a baby bottle, the baby bottle having a bottom, the stir insert comprising:
a ring shaped member configured to fit inside the baby bottle and including a radially inwardly extending tab; and
a flexible elongate member coupled to the tab and extending from the tab at an angle with respect to the central axis of the ring shaped member toward the bottom when the ring shaped member is fitted inside the baby bottle.

111. The stir insert of claim 110, wherein the elongate member includes a broad portion and a narrow portion.

112. The stir insert of claim 111, wherein the narrow portion is proximal the ring shaped member and the broad portion defines a distal end of the elongate member.

113. The stir insert of claim 111, wherein the broad portion defines openings through which fluid in the cylindrical container can flow during movement of the broad portion.

114. The stir insert of claim 110, wherein the elongate member moves back and forth when the container is shaken, and wherein the elongate member is resilient and returns to an original position after moving back and forth.

115. The stir insert of claim 110, wherein the flexible elongate member defines a plurality of holes.

116. The stir insert of claim 115, wherein the ring shaped member and the tab are relatively rigid, and wherein the flexible elongate member is relatively flexible.

117. A baby bottle comprising:
a container for liquids, the container comprising:
an opening defined by a rim;
sidewalls extending from the rim to a bottom to define an interior; and
a stir insert comprising:
an inner collar with an external diameter to fit within the opening and including a radially inwardly extending tab; and
a paddle portion supported by the inner collar and coupled to the tab such that the paddle portion extends from the tab toward the bottom at an angle with respect to the central axis of the container.

118. The baby bottle of claim 117, wherein the paddle portion extends into a lower half of the interior and does not contact the bottom of the container.

119. A stirring insert for a baby bottle, the baby bottle having an opening, the stirring insert comprising:
an inner collar with an external diameter sized to fit inside the opening and including a radially inwardly extending tab; and
a paddle portion coupled to the tab and extending away from the opening at an angle with respect to the central axis of the bottle.

120. The stirring insert of claim 119, wherein the paddle portion includes a narrow portion and a broad portion, and wherein the broad portion is farther from the opening than the narrow portion.

121. The stirring insert of claim 120, wherein the paddle portion oscillates when the baby bottle is shaken.

122. The stirring insert of claim 121, wherein the narrow portion bends and flexes as the broad portion moves back and forth.

123. A stirring insert for a baby bottle, the baby bottle defining a mouth, the stir insert comprising:
a support member securable within the mouth of the baby bottle and including a radially inwardly extending tab; and
a paddle portion supported by the support member, wherein the paddle portion is coupled to the tab and extends away from the mouth and toward the center of the support member at an angle with respect to the central axis of the support member and is flexible to move back and forth when the baby bottle is shaken.

124. The stirring insert of claim 123, wherein the paddle portion includes a narrow portion proximal to the opening and a broad portion spaced from the opening, wherein the broad portion defines one or more openings, wherein formula and liquid in the baby bottle pass through the one or more openings when the baby bottle is shaken.

125. The stirring insert of claim 123, wherein the support member defines an aperture that receives an insert portion of an upper end of the paddle portion.

126. The stirring insert of claim 125, wherein the insert portion includes a shaft extending from the upper end of the paddle portion, the shaft transitions into a widened portion, and the widened portion includes a tapered portion that transitions into a protruding portion.

127. The stirring insert of claim 125, wherein an upper end of the paddle portion attaches to the support member by a flanging connection that holds the upper end of the paddle portion to the support member.

128. The stirring insert of claim 125, wherein the insert portion includes a shaft extending from the upper end of the paddle portion, the shaft transitions into a widened portion, and a wall extends away from the shaft.

129. The stirring insert of claim 125, wherein the insert portion includes a shaft extending from the upper end, the shaft transitions into a widened portion, and a wall extends away from the shaft, wherein the aperture includes a wide opening portion and a narrow opening portion, and wherein the widened portion passes through the wide opening portion, and the wall inserts into the narrow opening portion.

130. The stirring insert of claim 125, wherein an outer diameter of the widened portion squeezes through the wide opening portion and is lockingly held in place as sides of the wide opening portion are received by an annular notch formed between the widened portion and the upper end of the paddle portion.

131. The stirring insert of claim 123, wherein the paddle portion is removably coupled to the support member.

132. A baby bottle comprising:
a container including a rim defining an opening, sidewalls extending from the opening to define an interior, and a bottom;
a stir insert including ring shaped support member that fits in the opening and a mixing member coupled to the support member, the support member including a tab that extends radially inwardly and toward the bottom of the container, the mixing member coupled to the tab, the mixing member including a flexible elongated narrow portion extending downwardly and toward a center of the container at an angle with respect to the central axis of the container, and a broad paddle portion at an end of the narrow portion, the broad paddle portion positioned in a lower half of the interior and defining an opening;
a nipple covering the opening; and
a clamp ring engaging the rim, the clamp ring securing the nipple and the stir insert to the container, wherein the broad paddle portion moves side to side within the interior to agitate liquid held by the container when the baby bottle is shaken.
